(19) United States
(12) Patent Application Publication
(10) Pub. No.: US 2005/0073385 A1
(43) Pub. Date: Apr. 7, 2005

(54) Transformer

(76) Inventors: Chen-Feng Wu, Taoyuan County (TW); Ming Yeh, Taoyuan County (TW)

Correspondence Address: BIRCH STEWART KOLASCH & BIRCH, PO BOX 747, FALLS CHURCH, VA, 22040-0747, US

(21) Appl. No.: 10/775,211

(22) Filed: Feb. 11, 2004

(30) Foreign Application Priority Data
Oct. 2, 2003 (TW) 092127272

(51) Int. Cl. H01F 27/30

(52) U.S. Cl. 336/208

(57) ABSTRACT

A transformer. A transformer includes an iron core structure, a first bobbin, a first primary coil, a first secondary coil, a second bobbin, a second primary coil and a second secondary coil. The first bobbin has a first hollow portion and a second hollow portion. The iron core structure passes through and surrounds the first and second hollow portions. The first primary coil is wound on the first hollow portion. The first secondary coil is wound on the second hollow portion. The second bobbin has a third hollow portion and a fourth hollow portion. The iron core structure passes through and surrounds the third and fourth hollow portions. The second primary coil is wound on the third hollow portion. The second secondary coil is wound on the fourth hollow portion.

### BACKGROUND OF THE INVENTION

1. Field of the Invention

The present invention relates to a transformer and in particular to a transformer with fewer components.

2. Description of the Related Art

A conventional transformer is generally constructed such that primary coils and secondary coils are wound around a hollow bobbin, with a core structure inserted into the center of the bobbin. FIG. 1 shows an embodiment of the conventional transformer. The conventional transformer 1 has two E-shaped cores 12 and 12 which can be combined to form a closed magnetic loop. Further, the conventional transformer 1 has a bobbin 10, with a primary winding area 101 and a secondary winding area 102, and pins 103 for connecting the wire of the coils to the circuit board (not shown) are provided on the two ends of the bobbin 10. A flange 104 is provided between the primary winding area 101 and the secondary winding area 102, and flanges 105 are provided to separate the secondary winding area 102 into several wound areas in order to prevent arcing faults resulting from the high voltage difference between the two adjacent layers of coils.

In the aforementioned structure of the conventional transformer, two transformers are required for two output sets, and a plurality of transformers are also required.

### SUMMARY OF THE INVENTION

In order to address the disadvantages of the aforementioned transformer, the present invention provides a transformer with fewer components still providing necessary outputs.

The present invention discloses a transformer including an iron core structure, a first bobbin, first primary coils, first secondary coils, a second bobbin, second primary coils and second secondary coils. The first bobbin has a first hollow portion and a second hollow portion. The iron core structure passes through and surrounds the first and second hollow portions. The first primary coils are wound on the first hollow portion. The first secondary coils are wound on the second hollow portion. The second bobbin has a third hollow portion and a fourth hollow portion. The iron core structure passes through and surrounds the third and fourth hollow portions. The second primary coils are wound on the third hollow portion. The second secondary coils are wound on the fourth hollow portion.

Further, in the transformer of the present invention, the first bobbin is disposed substantially parallel to the second bobbin.

The density of the coils wound on the second and fourth hollow portions is greater than that of the coils wound on the first and third hollow portions.

The iron core structure includes a first core portion, a second core portion and a third core portion. The first core portion passes through the first bobbin, the second core portion passes through the second bobbin, and the third core potion surrounds the first and second bobbins.

The first bobbin further includes a first protrusion separating the first and second hollow portions, and the second bobbin further includes a second protrusion separating the third and fourth hollow portions.

Further, the transformer of the present invention further includes insulating cover covering the first and second bobbins.

The insulating cover mentioned above has a separating plate to separate the first and second bobbins.

The first bobbin further includes a first engaging portion and the second bobbin further includes a second engaging portion. The first engaging portion engages the second engaging portion to connect the two bobbins.

Further, the first engaging portion may be a protruding portion and the second engaging portion may be a matching recessed portion, or vice versa.

The present invention discloses a transformer including a plurality of bobbins, a plurality of primary coils, a plurality of secondary coils and an iron core structure. The bobbins are disposed parallel to each other. The primary coils are wound on one end of each bobbin. The secondary coils are wound on the other end of each bobbin. The iron core structure passes through and surrounds every bobbin.

Thus, the advantage of the present invention is fewer components and simplified assembly.

### DESCRIPTION OF THE DRAWINGS

The present invention can be more fully understood by reading the subsequent detailed description in conjunction with the examples and references made to the accompanying drawings, wherein:

FIG. 1 is a perspective exploded view of a conventional transformer;

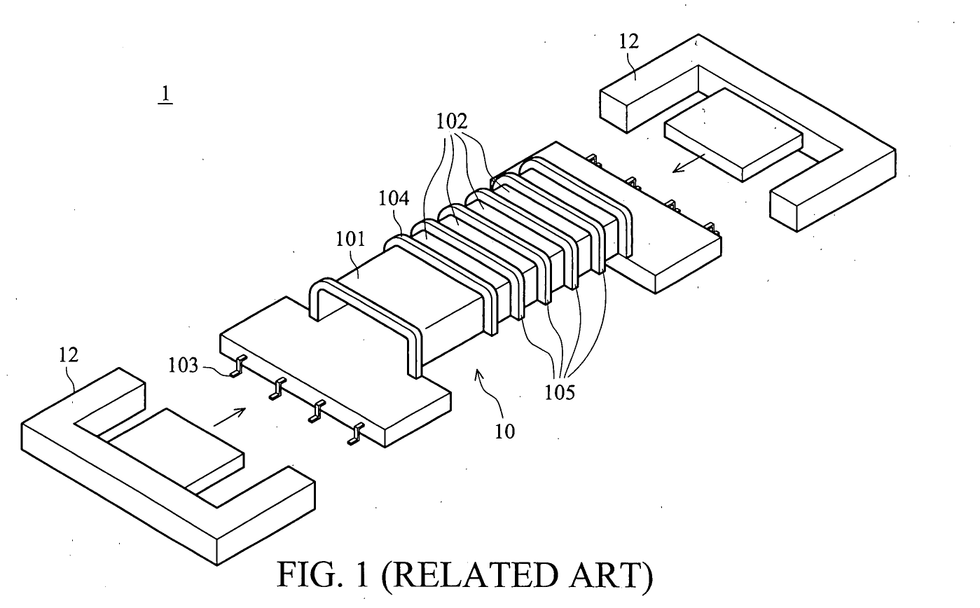

FIG. 2a is a perspective exploded view of a transformer of the present invention;

FIG. 2b is a cross-section of the first bobbin wound with first primary and secondary coils in the transformer of the present invention.

### DETAILED DESCRIPTION OF THE INVENTION

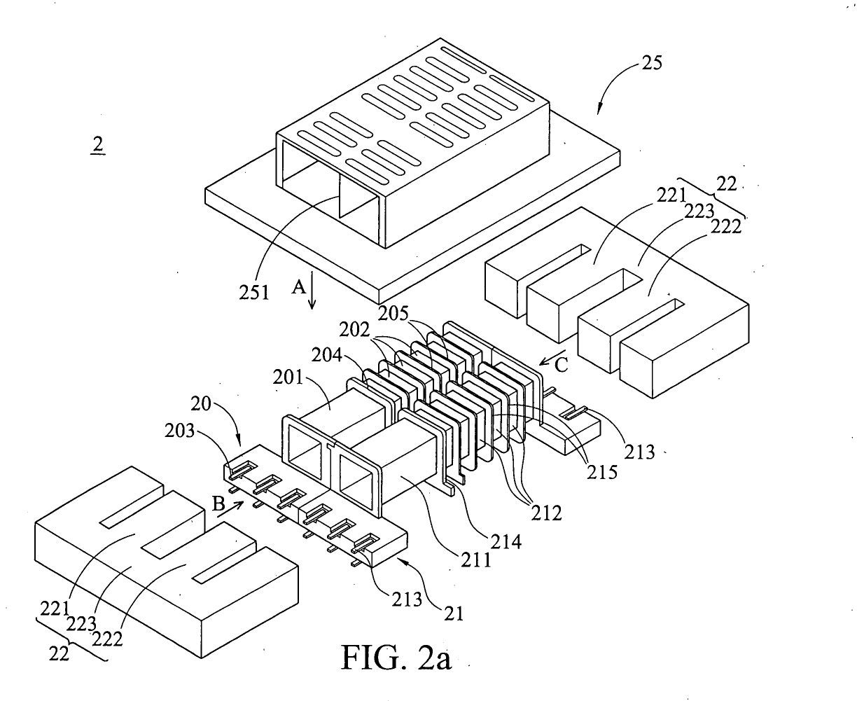

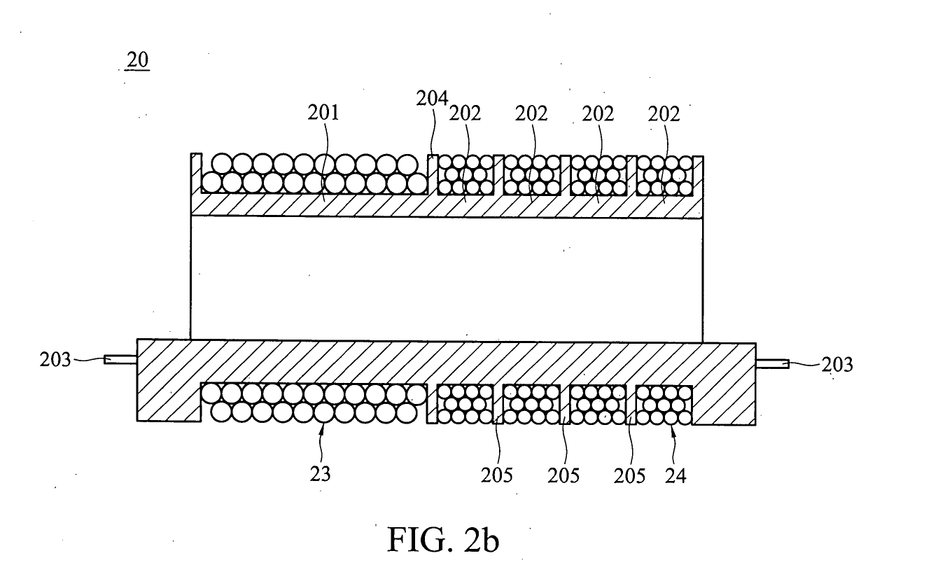

A preferred embodiment of the transformer of the present invention is shown in FIGS. 2a and 2b. FIG. 2a is a perspective exploded view of the transformer. FIG. 2b is a cross-section of the first bobbin wound with first primary and secondary coils of the transformer. The cross-section of the first and second bobbins 20 and 21 is approximately the same, therefore, showing only the first bobbin 20 to describe the present invention.

The transformer 2 of the present invention includes a first bobbin 20, a second bobbin 21, an iron core structure 22, first primary coils 23, first secondary coils 24, an insulating cover 25, second primary coils (not shown and wound on the second bobbin 21) and second secondary coils (not shown and wound on the second bobbin 21).

The first bobbin 20 includes a first hollow portion 201 and a second hollow portion 202. Pins 203 connecting the wire of the coils to the circuit board (not shown) are provided on the two ends of the first bobbin 20. The first hollow portion 201 and the second hollow portion 202 are separated by a first protrusion 204. The second hollow portion 202 is separated into several wound areas by a plurality of flanges 205.

The second bobbin 21 includes a third hollow portion 211 and a fourth hollow portion 212. Pins 213 connecting the wire of the coils to the circuit board (not shown) are provided on the two ends of the second bobbin 21. The second hollow portion 211 and the fourth hollow portion 212 are separated by a second protrusion 214. The fourth hollow portion 212 is separated into several wound areas by a plurality of flanges 215.

The iron core structure 22 has a first core portion 221, a second core portion 222 and a third core portion 223. The first core portion 221 and the second core portion 222 are substantially parallel, and the third core portion 223 connects the first core portion 221 and the second core portion 222.

The first bobbin 20 and the second bobbin 21 are in parallel, engaging to each other, that is between the connection of the first bobbin 20 and the second bobbin 21, a first engaging portion and a matching second engaging portion are provided. One example provides a protruding portion on the first bobbin 20, engaged by a matching recessed portion on the second bobbin 21. Another example provides reverse arrangement thereof. The invention is not limited, however, to the disclosed embodiments.

The first primary coils 23 are then wound around the first hollow portion 201, the first secondary coils 24 are wound around the second hollow portion 202, the second primary coils are wound around the third hollow portion 211, and the second secondary coils are wound around the fourth portion 212. The density of the windings on the second and fourth hollow portions 202 and 212 exceeds that of the first and third hollow portions 201 and 211.

Next, the insulating cover 25 is disposed on the first bobbin 20 and the second bobbins 21 as shown in arrow A. The insulating cover 25 may comprise a separating plate 251 to separate the bobbins 20 and 21.

The iron core structure 22 passes through and surrounds the first and second bobbins 20 and 21 as shown by arrow B and arrow C. The first core portion 221 of the iron core structure 22 passes through the first bobbin 20, the second core portion 222 of the iron core structure 22 passes through the second bobbin 21, and the third core portion 223 surrounds the first and second bobbins 20 and 21. The first core portion 221, the second core portion 222 and the third core portion 223 can be combined to form a closed magnetic loop.

As mentioned, the transformer of the present invention can provide two outputs. In addition, if a plurality of outputs is required, a plurality of bobbins may be utilized in parallel. A primary coil and a secondary coil are wound around each bobbin. Finally, an iron core structure corresponding to the bobbins passes through and surrounds the bobbins so as to provide required outputs.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A transformer comprising:
an iron core structure;
a first bobbin comprising a first hollow portion and a second hollow portion, wherein the iron core structure passes through and surrounds the first and second hollow portions;
a first primary coil wound on the first hollow portion;
a first secondary coil wound on the second hollow portion;
a second bobbin comprising a third hollow portion and a fourth hollow portion, wherein the iron core structure passes through and surrounds the third and fourth hollow portions;
a second primary coil wound on the third hollow portion; and
a second secondary coil wound on the fourth hollow portion.

2. The transformer as claimed in claim 1, wherein the first bobbin is disposed substantially parallel to the second bobbin.

3. The transformer as claimed in claim 1, wherein the density of the windings on the second and fourth hollow portions exceeds the density of the windings on the first and third hollow portions.

4. The transformer as claimed in claim 1, wherein the iron core structure comprises a first core portion, a second core portion and a third core portion, the first core portion passes through the first bobbin, the second core portion passes through the second bobbin, and the third core potion surrounds the first and second bobbins.

5. The transformer as claimed in claim 1, wherein the first bobbin further comprises a first protrusion to separate the first and second hollow portions, and the second bobbin further comprises a second protrusion to separate the third and fourth hollow portions.

6. The transformer as claimed in claim 1, further comprising an insulating cover disposed on the first and second bobbins.

7. The transformer as claimed in claim 6, wherein the insulating cover comprises a separating plate to separate the first and second bobbins.

8. The transformer as claimed in claim 1, wherein the first bobbin further comprises a first engaging portion and the second bobbin further comprises a second engaging portion, and the first engaging portion engages the second engaging portion to connect the first bobbin with the second bobbin.

9. The transformer as claimed in claim 8, wherein the first engaging portion comprises a protruding portion and the second engaging portion comprises a matching recessed portion, and the protruding portion and the matching recessed portion match up to each other.

10. The transformer as claimed in claim 8, wherein the first engaging portion comprises a matching recessed portion and the second engaging portion comprises a protruding portion, and the protruding portion and the matching recessed portion match up to each other.

11. A transformer comprising:
a plurality of bobbins disposed parallel to each other;
a plurality of primary coils wound on one end of each bobbin;
a plurality of secondary coils wound on the other end of each bobbin; and
an iron core structure passing through and surrounding each bobbin.
